(19) United States
(12) Patent Application Publication
(10) Pub. No.: US 2006/0090029 A1
(43) Pub. Date: Apr. 27, 2006

(54) Flash memory system and erase method thereof

(76) Inventor: Seung Ho Chang, Cheonju-Shi (KR)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/011,962

(22) Filed: Dec. 14, 2004

(30) Foreign Application Priority Data
Oct. 25, 2004 (KR) 2004-85423

(51) Int. Cl. G06F 12/00

(52) U.S. Cl. 711/103

(57) ABSTRACT

A flash memory system in which data for erase stored in a flash memory for main storage is stored in a flash memory for erase information storage, the data for erase stored in the flash memory for main storage is erased firstly, and the data for erase stored in the flash memory for erase information storage is then erased secondarily, and erase method thereof are provided. Twice erase commands are performed, unlike an existing flash memory system in which data is erased at once. Therefore, it is possible to prevent data from being erased by mistake when the data is stored.

1. FIELD OF THE TECHNOLOGY

This disclosure relates generally to a flash memory system in which data can be erased with it being divided into the first and the second, and erase method thereof, and, more specifically, to a flash memory system in which data can be erased twice using at least one flash memory for main storage (flash memory for storing first data) and at least one flash memory for erase information storage (flash memory for storing second data), and an erase method thereof.

### 2. BACKGROUND

Generally, a flash memory is a semiconductor storage device of properties which have low energy consumption and have its stored information not eased even when power is out. That is, the flash memory is a kind of a non-volatile memory to which power is consistently supplied. It can retain its stored information although power is not applied thereto, unlike DRAM, and has its information freely inputted thereto and outputted therefrom. With these properties, the flash memory has been widely applied to a variety of products, such as a digital television, a digital camcorder, a digital camera, a portable phone, a personal digital assistant (PDA), a game machine and a MP3 player.

A conventional flash memory system includes two or more flash memories and a controller for controlling these flash memories. Common information is programmed/erased into/from these flash memories. In the conventional flash memory system, however, if a user issues an erase command, data stored in the flash memory is deleted at once. Accordingly, there is a problem in that important data can be easily deleted, which makes restoration of the data impossible.

### SUMMARY

In one aspect, the invention is directed to an erase method of a flash memory system including at least one flash memory for main storage, at least one flash memory for erase information storage, and a controller for controlling the flash memory for main storage and the flash memory for erase information storage, may include requesting a temporary erase command for temporarily erasing data to the flash memory for main storage, determining whether a free space in which data can be stored exists in the flash memory for erase information storage, if it is determined that the free space exists in the flash memory for erase information storage, storing data for erase, which is stored in the flash memory for main storage, in the flash memory for erase information storage, firstly erasing the data for erase, which is stored in the flash memory for main storage, requesting a complete erase command for completely erasing data to the flash memory for erase information storage, and secondarily completely erasing the data for erase, which is stored in the flash memory for erase information storage.

The erase method may further include if it is determined that the free space does not exist in the flash memory for erase information storage, directly requesting the complete erase command to the flash memory for erase information storage and then completely erasing the data for erase, which is stored in the flash memory for erase information storage, whereby temporary erase is made possible.

In another aspect, the invention is directed to a flash memory system, which may include at least one flash memory for main storage to which a temporary erase command for temporarily erasing data is requested, at least one flash memory for erase information storage to which a complete erase command for completely erasing data is requested, and a controller for determining whether a free space in which data can be stored exists in the flash memory for erase information storage, wherein if it determined that the free space exists in the flash memory for erase information storage, the controller requests the temporary erase command to the flash memory for main storage, stores data for erase, which is stored in the flash memory for main storage, in the flash memory for erase information storage, firstly erases the data for erase, which is stored in the flash memory for main storage, requests the complete erase command to the flash memory for erase information storage, and then secondarily erases the data for erase, which is stored in the flash memory for erase information storage.

If it determined that the free space does not exist in the flash memory for erase information storage, the controller directly requests the complete erase command to the flash memory for erase information storage and completely erases the data for erase, which is stored in the flash memory for erase information storage, whereby temporary erase is possible.

### BRIEF DESCRIPTION OF THE DRAWINGS

FIG. 1 is a block diagram illustrating a flash memory system; and

FIG. 2 is a flowchart for explaining a method of erasing a flash memory system.

### DETAILED DESCRIPTION

An example of a flash memory system is disclosed in which data for erase stored in a flash memory for main storage is stored in a flash memory for erase information storage (e.g., a flash memory having a function such as a waste basket in Microsoft Windows™), the data for erase stored in the flash memory for main storage is erased firstly, and the data for erase stored in the flash memory for erase information storage is then secondarily completely erased.

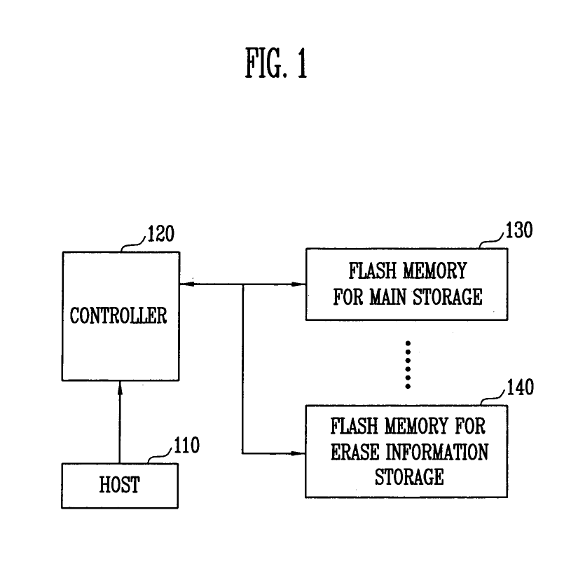

FIG. 1 is a block diagram illustrating an example of a flash memory system.

Referring to FIG. 1, the flash memory system includes a host 110, a controller 120, at least one flash memory for main storage 130, and at least one flash memory for erase information storage 140.

In this time, the flash memory for main storage 130 and the flash memory for erase information storage 140 have the same structure. In this case, the flash memory 130 and the flash memory 140 can share a portion of a single chip or share several chips with them being divided in a proper number. This can be set when designing the controller. For example, the smaller the size of the flash memory for erase information storage 140, the less the amount of data stored therein. Therefore, the data of the flash memory for erase information storage 140 is erased frequently. In this case, the flash memory for erase information storage 140 having a size enough to cover important data such as a program code can be used.

The flash memory for main storage 130 stores stored data for erase in the flash memory for erase information storage 140 and then firstly erases the stored data for erase, if a temporary erase command for temporarily erasing data is received.

The flash memory for erase information storage 140 secondarily completely erases the stored data for erase, if a complete erase command for completely erasing data is received.

The controller 120 requests the temporary erase command for temporarily erasing data to the flash memory for main storage 130, if an erase command is requested by the flash memory for main storage 130 and the flash memory for erase information storage 140 at the same time. The controller 120 then determines whether a free space (sector in which data is not written) into which data can be stored exists in the flash memory for erase information storage 140. In this time, the determination of the free space is made possible by writing program information into a spare cell, etc.

If it is determined that the free space exists in the flash memory for erase information storage 140, the controller 120 reads data for erase to be erased from the flash memory for main storage 130, and stores the read data in a buffer memory (not shown) of the controller 120. Thereafter, the controller 120 stores the data for erase, which is stored in the buffer memory, in the flash memory for erase information storage 140 (actually, read and program operations are generated).

If it is determined that the data for erase is completely stored in the flash memory for erase information storage 140, the controller 120 firstly erases the data for erase, which is stored in the flash memory for main storage 130. Next, the controller 120 requests the complete erase command for completely erasing data to the flash memory for erase information storage 140, and then secondarily erases the data for erase stored in the flash memory for erase information storage 140, thus completely erasing the data for erase.

Meanwhile, if it is determined that the free space does not exist in the flash memory for erase information storage 140, the controller 120 requests the complete erase command for completely erasing data to the flash memory for erase information storage 140 and then completely erases the data for erase stored in the flash memory for erase information storage 140, whereby temporary erase is possible.

In addition, if the free space does not exist in the flash memory for erase information storage 140, the controller 120 can inform the host 110 of the fact and then erases data after receiving a permission from the host 110.

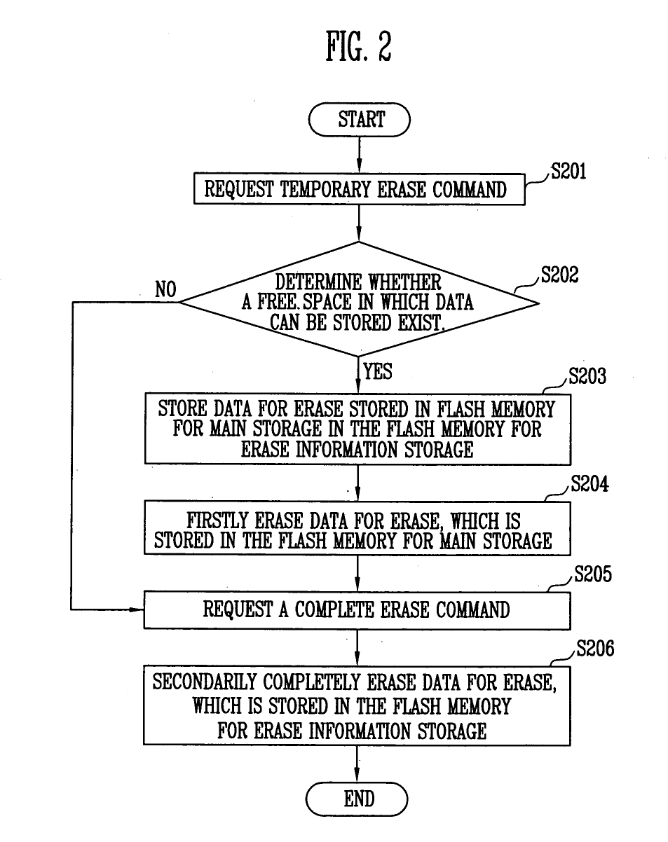

An erase method of the flash memory system using the at least one flash memory for main storage 130 and the at least one flash memory for erase information storage 140 having an operational characteristic in which a method for performing twice erase operations is possible, as stated previously, will now be described with reference to the flowchart shown in FIG. 2.

Referring to FIG. 2, the erase method of the flash memory system first includes requesting the temporary erase command to the flash memory for main storage 130 (S201).

It is determined whether a free space in which data can be stored exists in the flash memory for erase information storage 140 (S202). In this time, if it is determined that the free space exists in the flash memory for erase information storage 140, data for erase to be erased is read from the flash memory for main storage 130, stored in the buffer memory (not shown) of the controller 120 and then stored in the flash memory for erase information storage 140 (S203) (actually, read and program operations are generated)

Thereafter, if it is determined that the data for erase is completely stored in the flash memory for erase information storage 140, the data for erase to be erased, which is stored in the flash memory for main storage 130, is firstly erased (S204).

If the step S204 is completed, the controller 120 requests a complete erase command to the flash memory for erase information storage 140 (S205) and secondarily completely erases the data for erase, which is stored in the flash memory for erase information storage 140 (S206).

Returning back to the step S202, if it is determined that the free space does not exist in the flash memory for erase information storage 140, the process directly moves to the step S205 in which the controllers requests the complete erase command for completely erasing data to the flash memory for erase information storage 140, and then moves to the step S206 in which information of the flash memory for erase information storage 140 is completely erased, whereby temporary erase is possible.

The flash memory system described above can be applied to a shape such as a compact flash card and a shape inserted into a mobile, etc. It can be also applied to a NAND flash memory of a high capacity and a NOR flash memory of a high processing speed.

As described above, twice erase commands are performed, unlike an existing flash memory system in which data is erased at once. This is advantageous in that it can prevent data from being erased by mistake when the data is stored.

Although certain examples of methods and apparatus constructed in accordance with the teachings of the invention have been described herein, the scope of coverage of this patent is not limited thereto. On the contrary, this patent covers all embodiments of the teachings of the invention fairly falling within the scope of the appended claims literally or under the doctrine of equivalents.

What is claimed is:

1. An erase method of a flash memory system including at least one flash memory for main storage, at least one flash memory for erase information storage, and a controller for controlling the flash memory for main storage and the flash memory for erase information storage, comprising:
requesting a temporary erase command for temporarily erasing data to the flash memory for main storage;
determining whether a free space in which data can be stored exists in the flash memory for erase information storage;
if it is determined that the free space exists in the flash memory for erase information storage, storing data for erase, which is stored in the flash memory for main storage, in the flash memory for erase information storage;
firstly erasing the data for erase, which is stored in the flash memory for main storage;
requesting a complete erase command for completely erasing data to the flash memory for erase information storage; and
secondarily completely erasing the data for erase, which is stored in the flash memory for, erase information storage.

2. The erase method as claimed in claim 1, further comprising: if it is determined that the free space does not exist in the flash memory for erase information storage, directly requesting the complete erase command to the flash memory for erase information storage and then completely erasing the data for erase, which is stored in the flash memory for erase information storage, whereby temporary erase is made possible.

3. A flash memory system, comprising:
at least one flash memory for main storage to which a temporary erase command for temporarily erasing data is requested;
at least one flash memory for erase information storage to which a complete erase command for completely erasing data is requested; and
a controller for determining whether a free space in which data can be stored exists in the flash memory for erase information storage,
wherein if it determined that the free space exists in the flash memory for erase information storage, the controller requests the temporary erase command to the flash memory for main storage, stores data for erase, which is stored in the flash memory for main storage, in the flash memory for erase information storage, firstly erases the data for erase, which is stored in the flash memory for main storage, requests the complete erase command to the flash memory for erase information storage, and then secondarily erases the data for erase, which is stored in the flash memory for erase information storage.

4. The flash memory system as claimed in claim 3, wherein, if it determined that the free space does not exist in the flash memory for erase information storage, the controller directly requests the complete erase command to the flash memory for erase information storage and completely erases the data for erase, which is stored in the flash memory for erase information storage, whereby temporary erase is possible.
